(19) United States
(12) Patent Application Publication
(10) Pub. No.: US 2020/0259180 A1
(43) Pub. Date: Aug. 13, 2020

(54) PRELITHIATED MULTILAYER DRY ELECTRODE AND METHODS

(71) Applicant: Maxwell Technologies, Inc., San Diego, CA (US)

(72) Inventors: Joon Ho Shin, San Diego, CA (US); Hieu Minh Duong, Rosemead, CA (US); Vicente Tapia, Chula Vista, CA (US)

(21) Appl. No.: 16/742,569

(22) Filed: Jan. 14, 2020

Related U.S. Application Data
(60) Provisional application No. 62/793,338, filed on Jan. 16, 2019.

(51) Int. Cl. H01M 4/62; H01M 4/04; H01M 4/1391; H01M 4/1393; H01M 4/36; H01M 10/0525

(52) U.S. Cl. CPC H01M 4/62; H01M 4/043; H01M 4/0402; H01M 4/505; H01M 4/1393; H01M 4/366; H01M 10/0525; H01M 4/1391

(57) ABSTRACT

Provided herein are multilayer dry films for electrode film fabrication, and electrode films, electrodes, and energy storage devices that implement the multilayer dry films. The multilayer dry film for electrode film fabrication comprises a dry free-standing active layer comprising a first dry active material and a first dry binder, and a dry prelithiating layer comprising lithium, such that the first dry free-standing active layer and the dry prelithiating layer are laminated to each other to form a free-standing multilayer dry film.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. This application claims the benefit of U.S. Provisional App. No. 62/793,338, filed on Jan. 16, 2019, the entirety of which is hereby incorporated by reference.

### BACKGROUND

### Field

The present disclosure relates generally to energy storage devices, and specifically to materials and methods for prelithiated multilayer dry electrode films that form electrodes for use in energy storage devices.

### Description of the Related Art

Energy storage devices, such as lithium ion based energy storage devices, may be used to power a diverse range of electronic devices. For example, batteries and/or capacitors using these materials can be implemented in a variety of applications, including for example within wind power generation systems, uninterruptible power source systems (UPS), photo voltaic power generation, and/or energy recovery systems in industrial machinery and transportation systems. Electrodes of such batteries and/or capacitors may undergo a pre-doping process during fabrication of the electrodes.

### SUMMARY

For purposes of summarizing the invention and the advantages achieved over the prior art, certain objects and advantages of the invention are described herein. Not all such objects or advantages may be achieved in any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

One aspect, a multilayer dry film for electrode film fabrication is described. The multilayer dry film for electrode film fabrication comprises a dry free-standing active layer comprising a first dry active material and a first dry binder, and a dry prelithiating layer comprising lithium, such that the first dry free-standing active layer and the dry prelithiating layer are laminated to each other to form a free-standing multilayer dry film.

In some embodiments, the dry free-standing active layer comprises a first active layer, the multilayer dry film further comprises a second active layer, and the second active layer comprises a second active material. In some embodiments, the prelithiating layer is positioned between the first active layer and the second active layer. In some embodiments, the second active layer comprises a second dry active layer, the second active material comprises a second dry active material, and the second dry active layer further comprises a second dry binder.

In some embodiments, at least one of the type and amount of the first active material and the second active material is different between the first active layer and the second active layer. In some embodiments, the dry prelithiating layer comprises at least one of lithium foil, stabilized lithium metal powder (SLMP), and lithium-doped silicon, silicon oxide (SiO) or silicon compound. In some embodiments, the dry prelithiating layer comprises lithium foil. In some embodiments, the dry prelithiating layer comprises SLMP. In some embodiments, the dry prelithiating layer comprises lithium-doped SiO.

In some embodiments, a multilayer dry electrode film comprises the prelithiating layer positioned between the first active layer and the second active layer. In some embodiments, the first active layer and the second active layer have substantially the same compositions. In some embodiments, at least one of the first and second active material comprises at least one of sulfur and a material including sulfur.

In some embodiments, a multilayer dry electrode is described. The multilayer dry electrode comprises a current collector comprising a first side and a second side and the multilayer dry electrode film is laminated to the first side of the current collector, such that the multilayer dry electrode film comprises the prelithiating layer, positioned between the first active layer and the second active layer. In some embodiments, the multilayer dry electrode film is laminated directly onto the first side of the current collector. In some embodiments, an intervening adhesive layer is not provided between the multilayer electrode film and the current collector.

In some embodiments, a double-sided multilayer dry electrode is described. The double-sided dry electrode comprises the multilayer dry electrode and a second multilayer dry electrode film laminated to the second side of the current collector. In some embodiments, the first prelithiating layer of the first multilayer dry electrode is a different material from a second prelithiating layer of the second multilayer dry electrode film.

In some embodiments, the first multilayer dry electrode film is of the opposite polarity as the second multilayer dry electrode film. In some embodiments, the first multilayer dry electrode film and the second multilayer dry electrode film are symmetric with respect to each other. In some embodiments, the first multilayer dry electrode film and the second multilayer dry electrode film are asymmetric with respect to each other. In some embodiments, the first multilayer dry electrode film comprises a different number of layers than the second multilayer dry electrode film. In some embodiments, the active layer of the first multilayer dry electrode film that is immediately adjacent to the first side of the current collector has a different composition than an active layer of the second multilayer film that is immediately adjacent to the second side of the current collector. In some embodiments, an energy storage device comprising the double sided multilayer dry electrode is described.

In some embodiments, a method of fabricating a multilayer dry film for an electrode is described. The method comprises providing a dry free-standing active layer comprising a first dry active material and a first dry binder and forming a free-standing multilayer dry film by laminating a dry prelithiating layer comprising lithium onto the dry free-standing active layer.

In some embodiments, forming the free-standing multilayer dry film further comprises laminating a second active layer onto the dry prelithiating layer to form a multilayer dry electrode film. In some embodiments, the dry prelithiating layer comprises lithium foil. In some embodiments, the method further comprises compressing stabilized lithium metal powder (SLMP) to form the dry prelithiating layer. In some embodiments, compressing the SLMP and forming the free-standing multilayer dry film are performed approximately simultaneously. In some embodiments, compressing comprises calendering. In some embodiments, the method further comprises placing the SLMP onto the dry free-standing active layer prior to the compressing the SLMP. In some embodiments, at least one of the laminating steps is performed by a calendering process. In some embodiments, the method further comprises wet-coating a second active layer onto the dry prelithiating layer to form a multilayer dry electrode film.

In some embodiments, a method of fabricating a multilayer electrode is described. The method comprises fabricating a first multilayer dry electrode film according to the method as described above, providing a current collector comprising a first side and a second side, and laminating the first multilayer dry electrode film to the first side of the current collector to form a multilayer electrode. In some embodiments, the method further comprises providing a second multilayer dry electrode film and laminating the second multilayer dry electrode film to the second side of the current collector to form a double sided multilayer electrode.

In some embodiments, a method of making an energy storage device is described. The method comprises inserting the double sided multilayer electrode, as described above, into a container and adding electrolyte to the container. In some embodiments, the energy storage device comprises a battery.

In some embodiments, a method of prelithiating a multilayer dry film for an electrode is described. The method comprises fabricating a multilayer dry film, as described above, and tuning the amount of prelithiation. In some embodiments, tuning comprises compressing the multilayer dry film.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

FIGS. 1A-1C illustrate schematic diagrams of some embodiments as described herein.

FIGS. 2A-F illustrate prelithiated single side coated layer dry electrode configurations.

FIGS. 3A-3F illustrate prelithiated double side coated layer dry electrode configurations.

FIGS. 4A-C illustrate prelithiated double side coated layer dry electrode configurations.

FIGS. 5A-C illustrate prelithiated double side coated layer dry electrode configurations.

FIGS. 6A-J illustrate prelithiated single (or double) side layer dry electrode configurations.

FIGS. 7A-C illustrate hybrid prelithiated multilayer electrode configurations that incorporate wet coated electrodes as a matrix.

FIGS. 8A-D illustrate the distribution of SLMP on a dry film, on a carbon coated current collector foil, on a dry film laminated onto carbon-coated current collector foil, and on a base coat on Cu foil followed by SLMP dispersion, respectively.

FIGS. 9A-C are schematic drawings of Li foil lamination.

FIGS. 10A-C show illustrations of representative methods to laminate a Li-doped layered electrode.

FIGS. 11A-F illustrate images of prelithiated layer electrode preparations.

FIGS. 12A-F illustrate images of prelithiated layer electrode preparations.

FIGS. 13A-F illustrate images of prelithiated layer electrode preparations.

FIGS. 14A-B illustrate the differential capacity and voltage profiles of 1^{st} formation cycle for previously known dry electrode.

FIGS. 15A-B illustrate differential capacity and voltage profiles of 1^{st} formation cycle for dry film/Li foil/dry film/carbon-coated Cu foil layer electrode half pouch cell.

FIGS. 16A-B illustrate differential capacity and voltage profiles of 1^{st} formation cycle for Dry film/SLMP/Dry film/Carbon-coated Cu foil layer electrode half pouch cell.

FIGS. 17A-B illustrate differential capacity and voltage profiles of 1^{st} formation cycle for Dry film/SLMP/Carbon-coated Cu foil layer electrode half pouch cell.

FIGS. 18A-B illustrate differential capacity and voltage profiles of 1^{st} formation cycle for Dry film/SLMP/Bare Cu foil layer electrode half pouch cell.

FIGS. 19A-C report cell open circuit voltage (OCV) prior to 1^{st} formation cycle charge/discharge specific capacity and efficiency for four different electrode configuration.

FIGS. 20A-B illustrate the Nyquist plots of prelithiated layer electrode during rest period prior to formation of a dry film/Li foil/Dry film/Carbon-coated Cu foil and a Dry film/SLMP/Dry film/Carbon-coated Cu foil.

FIGS. 21A-B illustrate the Nyquist plots of prelithiated layer electrode measured after 1^{st} formation cycle of a Dry film/Li foil/Dry film/Carbon-coated Cu foil and a Dry film/SLMP/Dry film/Carbon-coated Cu foil.

FIGS. 22A-D illustrate images of electrodes based on Cell 1 as presented in FIGS. 15A-B.

FIGS. 23A-D illustrates images of electrodes based on Cell 1 as presented in FIGS. 16A-B.

FIGS. 24A-D illustrate images of electrodes based on Cell 1 as presented in FIGS. 17A-B.

FIGS. 25A-D illustrate configurations of single side layer electrode half cell and full cell where the anode consists of SLMP and Li foil for prelithiation.

### DETAILED DESCRIPTION

The present disclosure is related to multilayer electrode films including a prelithiating layer, and methods of fabricating thereof, for use in electrodes for an energy storage device. The prelithiating layer can be a separate layer laminated to a dry free-standing active layer. Such prelithiating layers can provide prelithiation while reducing issues that can arise where prelithiated material is mixed into the active material constituents, as described further herein. It will be understood that one or more electrodes formed from the multilayer electrode films described herein can be inserted into a container, and electrolyte can be added to the container, to form an energy storage device, such as a capacitor, battery, or other device that uses electrodes.

### Definitions

As provided herein, a “self-supporting” electrode film is an electrode film that incorporates binder matrix structures sufficient to support the film or layer and maintain its shape such that the electrode film or layer can be free-standing. When incorporated in an energy storage device, a self-supporting electrode film or active layer is one that incorporates such binder matrix structures. Generally depending on the methods employed, such electrode films or active layers are strong enough to be employed in energy storage device fabrication processes without any outside supporting elements, such as a current collector, support webs or other structures, although supporting elements may be employed to facilitate the energy storage device fabrication processes. For example, a “self-supporting” electrode film can have sufficient strength to be rolled, handled, and unrolled within an electrode fabrication process without other supporting elements. A dry electrode film, such as a cathode electrode film or an anode electrode film, may be self-supporting.

As provided herein, a “solvent-free” electrode film is an electrode film that contains no detectable processing solvents, processing solvent residues, or processing solvent impurities. A dry electrode film, such as a cathode electrode film or an anode electrode film, may be solvent-free.

A “wet” electrode, “wet process” electrode, or slurry electrode, is an electrode or comprises an electrode film prepared by at least one step involving a slurry of active material(s), binder(s), and optionally additive(s), even if a subsequent drying step removes moisture and solvent from the electrode or electrode film. Thus, a wet electrode or wet electrode film will include at least one or more processing solvents, processing solvent residues, and/or processing solvent impurities.

As used herein, a “dry free-standing active layer” and a “dry film” are used interchangeably. The terms “dry free-standing active layer ” and “dry film” are to be given their ordinary and customary meanings to a person of ordinary skill in the art. A dry free-standing active layer can refer to a layer comprising a first dry active material and a first dry binder.

### DESCRIPTION

High capacity anode materials such as silicon have been widely developed over past decades. However, silicon anodes still suffer from significant permanent lithium capacity loss during formation, resulting in reduced cell energy density. To reduce the loss, a silicon content in silicon-containing composite anodes can be reduced, or in some cases, the use of silicon anode in lithium ion batteries can be eliminated. Current commercial high capacity lithium ion batteries contain low content (about 5 wt % silicon or silicon oxide) in the graphite-based composite anode.

Prelithiation can be an important consideration for the realization of high capacity anodes. Direct incorporation of a prelithiation source by mixing chunks of elemental lithium formed from lithium ribbon or foil, or mixing stabilized lithium metal powder (SLMP) or granular lithium into a dry powder mixing step, such as that described in U.S. Pat. Pub. No. 2017/0244098 (incorporated by reference in its entirety), has presented challenges in the process steps in existing methods. Adhesion of lithium particles to the calender rolls was observed as a result of poorly distributed lithium metal in the mixing step, leading ultimately to holes in the active films. Previously known methods suffered from non-uniform dispersion of lithium metal, issues related to calendering prelithiated dry powder, loss of lithium during the calendering process, reaction of active lithium powder during the mixing and calendering processes, and relatively lower electrochemical utilization of the embedded lithium. New methods to overcome these challenges are desirable.

Provided herein are various embodiments incorporating electrodes and electrode film structures that include a prelithiating layer that is laminated to at least one dry free-standing active layer. Providing such a prelithiating layer allows for prelithiation without mixing the lithiating material into the active material constituents. Embodiments reduce or eliminate the aforementioned problems, while providing improved electrode performance. Embodiments can allow handling and “tuning” of a prelithiating layer (e.g., adjusting its thickness for example, by compressing the layer, when laminated to an active layer to affect the amount of prelithiation), prior to being laminated to a current collector. Embodiments can be implemented within various multi-layer electrodes and electrode film structures described herein, or other multi-layer structures, such as those described in U.S. patent application Ser. No. 16/176,420 (incorporated by reference herein in its entirety). For those multilayer embodiments described herein, the layers can be asymmetric (different types of materials, and/or different thicknesses), or symmetric (same materials and thicknesses) with respect to each other.

In some embodiments, an active layer of a multilayer dry film as provided herein includes at least one active material and at least one binder. In further embodiments, an active layer of a multilayer dry film as provided herein is a self-supporting layer. The at least one active material can be any active material known in the art. The at least one active material may include, for example, a carbon material, for example, graphitic material, graphite, graphene-containing materials, activated carbon, hard carbon, soft carbon, and/or carbon nanotubes. The at least one active material may include a battery active material, for example, a metal oxide, metal sulfide, or a lithium metal oxide. For example, the battery active material can include a lithium metal oxide, a layered transition metal oxide, spinel manganese oxide, or olivine. The lithium metal oxide can be lithium nickel manganese cobalt oxide (NMC), lithium manganese oxide (LMO), lithium nickel manganese oxide (LNMO), lithium iron phosphate (LFP), lithium cobalt oxide (LCO), lithium titanate, and/or lithium nickel cobalt aluminum oxide (NCA). The carbon can be porous carbon, graphite, conductive carbon, or a combination thereof. The binder can include PTFE, a polyolefin, poly(ethylene oxide) (PEO), styrene-butadiene, polyvinylene chloride, polyvinylidene chloride (PVDC), polyvinyl chloride (PVC), poly(phenylene oxide) (PPO), polyethylene-block-poly(ethylene glycol), polydimethylsiloxane (PDMS), polydimethylsiloxane-coalkylmethylsiloxane, co-polymers thereof, and/or admixtures thereof. In some embodiments, the one or more polyolefins can include polyethylene (PE), polypropylene (PP), polyvinylidene fluoride (PVDF), co-polymers thereof, and/or mixtures thereof. The binder can include a cellulose, for example, carboxymethylcellulose (CMC). In certain embodiments, the binder comprises, consists essentially, or consists of PTFE. In some embodiments, the binder comprises a fibrillizable polymer. An active layer as described herein can include a carbon coating on a current collector.

Electrode films described herein may advantageously exhibit improved performance relative to conventional films. The performance may be, for example, coulombic efficiency, capacity, cycling performance or conductivity.

Although certain embodiments and examples are described below, those of skill in the art will appreciate that the invention extends beyond the specifically disclosed embodiments and/or uses and obvious modifications and equivalents thereof. Thus, it is intended that the scope of the invention herein disclosed should not be limited by any particular embodiments described below.

By including a prelithiating layer laminated to a dry free-standing active layer, a pre-doped electrode can be fabricated. Without wishing to be limited by theory, it is thought that a prelithiating layer included in an electrode film may undergo redox processes to create free metal ions. Thus, an electrode as provided herein, when in contact with an electrolyte, may release an electron and subsequently form a metal cation per lithium metal atom. The released metal ions may diffuse to either electrode. For example, a typical anode material of an energy storage device generally will include one or more intercalating carbon components. The intercalating carbon components can be selected to intercalate certain metal ions, such as lithium ions. When an electrode includes a prelithiating layer as provided herein, the metal ions can intercalate in one or more active carbon components of an anode. Relatedly, cathode materials, for example, of capacitors, generally include carbon components capable of adsorbing metal ions, such as lithium ions. When a cathode is in contact with metal ions, the metal ions may adsorb to the surface of the cathode.

Thus, in some embodiments, the materials and methods provided herein may have the advantage of reducing the number of steps for pre-doping of an electrode. Specifically, no discrete pre-doping step need be performed on a pre-existing electrode film. Electrode films provided herein may allow intimate contact between a prelithiating layer and a plurality of carbon particles. Thus, the need for a pre-doping step that requires a separate electrical element providing electrical contact between the pre-doping material source (which may a source of metal ions, such as an elemental metal or solution of metal ions) and the carbon-based electrode is removed. Instead, embodiments herein may provide a pre-doped electrode with an electrode film that has prelithiating layer, which release metal ions upon contact with electrolyte within an energy storage device.

The cathode active material can be, for example, a metal oxide, metal sulfide, or a lithium metal oxide. The lithium metal oxide can be, for example, a lithium nickel manganese cobalt oxide (NMC), a lithium manganese oxide (LMO), a lithium iron phosphate (LFP), a lithium cobalt oxide (LCO), a lithium titanate, and/or a lithium nickel cobalt aluminum oxide (NCA). In some embodiments, cathode active materials can be comprised of, for example, a layered transition metal oxide (such as LiCoO₂ (LCO), Li(NiₓMn_{y}Co_{z})O₂ (NMC) and/or LiNi_{0.8}Co_{0.15}Al_{0.05}O₂ (NCA)), a spinel manganese oxide (such as LiMn₂O₄ (LMO) and/or LiMn_{1.5}Ni_{0.5}O₄ (LMNO)) or an olivine (such as LiFePO₄). In some embodiments, the cathode active material comprises, consists essentially of, or consists of a lithium metal oxide. Anode active materials can be comprised of, for example, an insertion material (such as carbon, graphite, lithium titanate (Li4Ti5O12) (LTO), and/or graphene), an alloying/dealloying material (such as silicon, silicon oxide, tin, and/or tin oxide), a metal alloy or compound (such as Si—Al, and/or Si—Sn), and/or a conversion material (such as manganese oxide, molybdenum oxide, nickel oxide, and/or copper oxide). The anode active materials can be used alone or mixed together to form multi-phase materials (such as Si—C, Sn—C, SiOx-C, SnOx-C, Si—Sn, Si—SiOx, Sn—SnOx, Si—SiOx-C, Sn—SnOx-C, Si—Sn—C, SiOx-SnOx-C, Si—SiOx-Sn, or Sn—SiOx-SnOx.). In some embodiments, the one or more other anode active materials can include hard carbon, soft carbon, graphene, mesoporous carbon, silicon, silicon oxides, tin, tin oxides, germanium, antimony, lithium titanate, titanium dioxide, mixtures, alloys, or composites of the aforementioned materials, and/or the like. In some embodiments, the anode active material comprises silicon particles. The silicon particles can be selected from silicon-containing materials provided herein.

The prelithiating layer can comprise, consist essentially of, or consist of lithium foil, SLMP, lithium-doped SiO. Although described primarily with reference to lithium metal, it will be understood that the apparatuses and/or processes described herein may also be modified to other compositions. For example, the apparatuses and/or processes described herein may be applied to provide compositions comprising one or more of lithium, sodium, potassium, magnesium and calcium.

In some embodiments, the binder may comprise a PTFE and one or more of a fluoropolymer, a cellulose, a polyolefin, a polyether, a precursor of polyether, a polysiloxane, co-polymers thereof, and/or admixtures thereof. In some embodiments, the polyolefin can include polyethylene (PE), polypropylene (PP), polyvinylidene fluoride (PVDF), co-polymers thereof, and/or mixtures thereof. The binder can include polyvinylene chloride, poly(phenylene oxide) (PPO), polyethylene-block-poly(ethylene glycol), poly(ethylene oxide) (PEO), poly(phenylene oxide) (PPO), polyethylene-block-poly(ethylene glycol), polydimethylsiloxane (PDMS), polydimethylsiloxane-coalkylmethylsiloxane, co-polymers thereof, and/or admixtures thereof. An admixture of binders may comprise interpenetrating networks of the aforementioned binders. In some embodiments, the binder can include a cellulose, for example, carboxymethyl cellulose (CMC).

It is contemplated that several factors impact the uniformity of prelithiation, prelithiation capacity, and electrochemical performance as well as large scale up of prelithiated layer electrode. The factors include: thickness of lithium foil and preference for thinner foil, particle size of SLMP and preference for smaller particle size, the amount of SLMP prelithiation, thickness of free-standing dry film, and amination pressure of prelithiated layer electrode.

It is contemplated that the invention disclosed herein can be applied to high energy solid state batteries, such as those described in PCT App. No. PCT/US2019/060263 (incorporated by reference herein in its entirety). It is contemplated that the invention disclosed herein can also be useful in conventional wet coated battery electrode-based multilayer electrode(s) and alternative dry processed electrode(s).

The configuration of layered dry electrode is not limited by these depictions herein, and can be expanded with different active material chemistry, dry film composition, dry film thickness, layer sequence, number of layer, symmetric layer double side, and asymmetric layer double side configuration.

In one aspect, the lithium metal source for prelithiation is incorporated at the film lamination steps, thus reducing surface contact between lithium metal and some processing equipment components. In some embodiments, the incorporation of the lithium metal source for prelithiation at the film lamination steps reduces imperfections in electrode, for example with high lithium metal concentration (>1 wt %).

There might be optimal range of particle size of SLMP and Li—SiO powder and thickness of lithium foil that can be used in prelithiated layer electrode.

In some embodiments, prelithiation methods using lithium foil, SLMP, and Li-doped silicon oxide in multilayer electrode laminates are described. In some embodiments, there is demonstrated effective processability of dry electrode films and energy gain in multilayer electrodes. In some embodiments, prelithiated multilayer dry coated electrode lamination is described. In some embodiments, the use of lithium foil, SLMP, and Li-doped SiO in prelithiated layer dry anode and cathode electrode is described. In some embodiments, calendering process for prelithiated layer electrodes by avoiding direct calendering contact to SLMP, Li foil and Li—SiO is described. In some embodiments, solvent-free prelithiated dry coated electrodes are described. In some embodiments, prelithiated dry electrodes production through roll-to-roll process are described. In some embodiments, roll-to-roll prelithiated electrode full cell production is described.

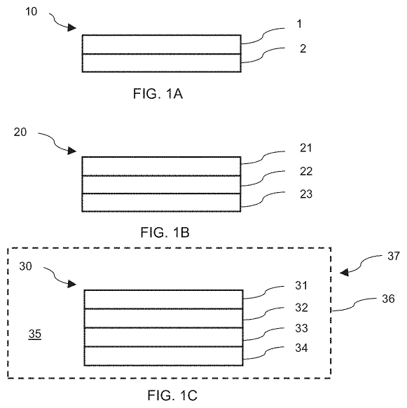

FIGS. 1A-1C illustrate schematic diagrams of some embodiments of the present invention as described herein. As shown in FIG. 1A, a multilayer dry film 10 for electrode film fabrication can comprise a dry free-standing active layer 1 comprising a first dry active material and a first dry binder. Film 10 can include a dry prelithiating layer 2 comprising lithium. The prelithiating layer 2 can be formed from a substantially solid material, such as pre-formed layer that is laminated onto the active layer 1. For example, the prelithiating layer 2 can comprise a lithium foil. Alternatively, the prelithiating layer 2 can be formed from a plurality of compressed particles, such as a powder like SLMP. The first dry free-standing active layer 1 and the dry prelithiating layer 2 can be laminated to each other as shown to form a free-standing multilayer dry film. These and other layers herein can be laminated to each other with conductive adhesive, and/or without conductive adhesive. For example, the binder(s) in the active layer may sufficiently adhere the layers together such that a separate adhesive or adhesive layer may not be needed. Thus, in some embodiments, the layers herein can be laminated directly onto each other. In some embodiments, an intervening adhesive layer is not provided between the layers herein.

As shown in FIG. 1B, a multilayer dry electrode film 20 for electrode film fabrication can comprise a dry free-standing active layer 21 and a dry prelithiating layer 22 which are similar to layers 1 and 2 in FIG. 1A. The film 20 can further include a second active layer 23, which can be a second free-standing active layer 23. Layer 23 can comprise a second active material and a second binder, such as a second dry active material and a second dry binder. The active layer 23 can comprise a second dry active layer. The dry prelithiating layer 22 can be positioned between the first dry free-standing active layer 21 and the second free-standing active layer 23.

As shown in FIG. 1C, a multilayer dry electrode 30 can comprise a current collector 34 comprising a first side and a second side, with a multilayer dry electrode film laminated to the first side of the current collector 34. The multilayer dry electrode film can comprise a dry prelithiating layer 32 positioned between a dry free-standing first active layer 31 and a second active layer 33. Layers 31, 32 and 33 can be similar to layers 21, 22 and 23 in FIG. 1B. The dry electrode 30 can be inserted into a container 35, into which electrolyte 36 can be added to form an energy storage device 37.

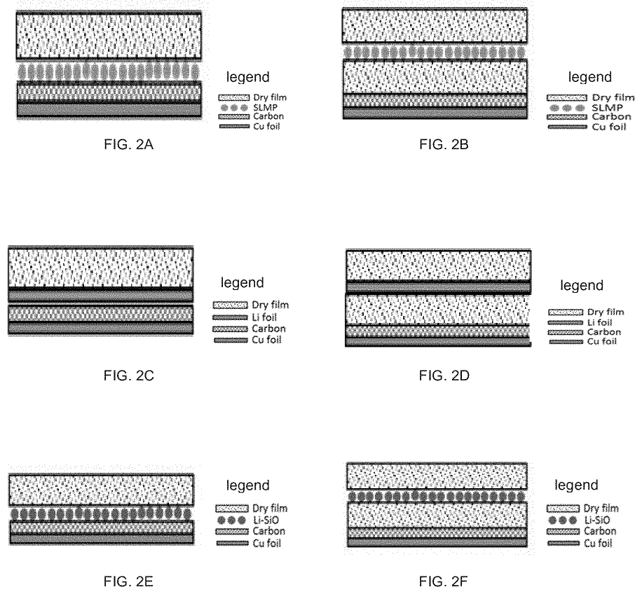

FIGS. 2A-6J illustrate schematic drawings of prelithiated layer dry electrode configurations which implement various combinations of multilayer dry film(s) (such as multilayer dry film 10 in FIG. 1A), multilayer dry electrode film(s) (such as the multilayer dry electrode film 20 in FIG. 1B), and multilayer dry electrode(s) (such as multilayer dry electrode 30 in FIG. 1C). Legends are provided for the materials in the figures as needed here and throughout, and the description for each lists the layers in the order shown.

Prelithiated single side coated layer dry electrode embodiments are shown in FIGS. 2A-F. FIG. 2A illustrates a multilayer dry electrode comprising a dry film layer, an SLMP layer, a carbon layer, and a current collector layer (Cu foil). The legend for FIG. 2A is shown to the immediate right of this figure. FIG. 2B illustrates a multilayer dry electrode comprising a dry film layer, an SLMP layer, a carbon layer, and a dry film layer, and a current collector layer (Cu foil). The legend for FIG. 2B is shown to the immediate right of this figure. FIG. 2C illustrates a multilayer dry electrode comprising a dry film, a lithium foil layer, carbon layer, and a current collector (Cu foil). The legend for FIG. 2C is shown to the immediate right of this figure. FIG. 2D illustrates a multilayer dry electrode comprising a dry film layer, a lithium foil, a carbon layer, a dry film layer, a carbon layer, and a current collector (Cu foil). The legend for FIG. 2D is shown to the immediate right of this figure. FIG. 2E illustrates a multilayer dry electrode comprising a dry film layer, a Li—SiO layer, a carbon layer, and a current collector layer (Cu foil). The legend for FIG. 2E is shown to the immediate right of this figure. FIG. 2F illustrates a multilayer dry electrode comprising a dry film layer, a Li—SiO layer, a dry film layer, a carbon layer, and a current collector layer (Cu foil). The legend for FIG. 2F is shown to the immediate right of this figure.

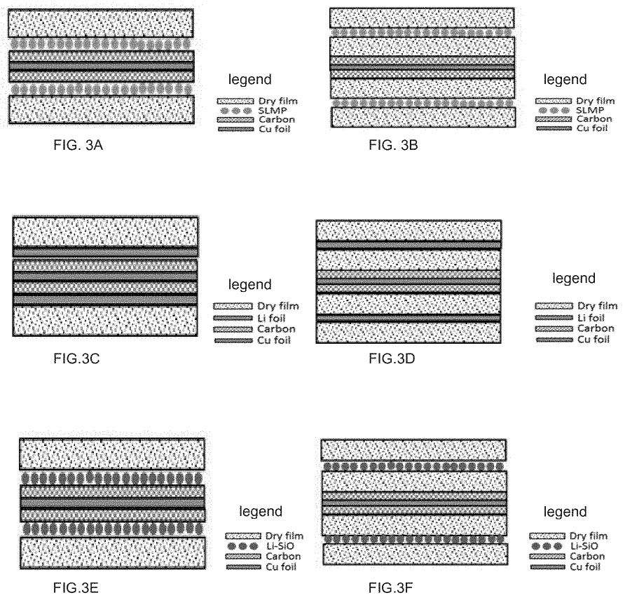

Prelithiated double side coated multilayer dry electrode configurations are shown in FIGS. 3A-3F

FIG. 3A illustrates a multilayer dry electrode comprising, in this order, a first dry film layer, a first SLMP layer, a first carbon layer, a Cu foil, a second carbon layer (such that the Cu foil is a carbon coated current collector, in between two carbon layers), a second SLMP layer, and a second dry film. The legend for FIG. 3A is shown to the immediate right of this figure. FIG. 3B illustrates a multilayer dry electrode comprising a first dry film layer, a SLMP layer, a second dry film layer, a carbon coated current collector comprising a Cu foil in between two carbon layers, a dry film layer, a SLMP layer, and a dry film layer. The legend for FIG. 3B is shown to the immediate right of this figure.

FIG. 3C illustrates a multilayer dry electrode comprising a dry film layer, a Li foil layer, a carbon coated current collector comprising a Cu foil in between two carbon layers, a Li foil layer, and a dry film layer. The legend for FIG. 3C is shown to the immediate right of this figure. FIG. 3D illustrates a multilayer dry electrode comprising a first dry film layer, a Li foil layer, a second dry film layers, a carbon coated current collector comprising a Cu foil in between two carbon layers, a third dry film layer, a Li foil layer, and a fourth dry film layer. The legend for FIG. 3D is shown to the immediate right of this figure.

FIG. 3E illustrates a multilayer dry electrode comprising a first dry film layer, a Li—SiO layer, a carbon coated current collector comprising a Cu foil between two carbon layers, a Li—SiO layer, and a second dry film layer. The legend for FIG. 3E is shown to the immediate right of this figure. FIG. 3F illustrates a multilayer dry electrode comprising a first dry film layer, a Li—SiO layer, a second dry film layer, a carbon coated current collector comprising Cu foil in between two carbon layers, a third dry film layer, a second Li—SiO layer, and a fourth dry film layer. The legend for FIG. 3F is shown to the immediate right of this figure.

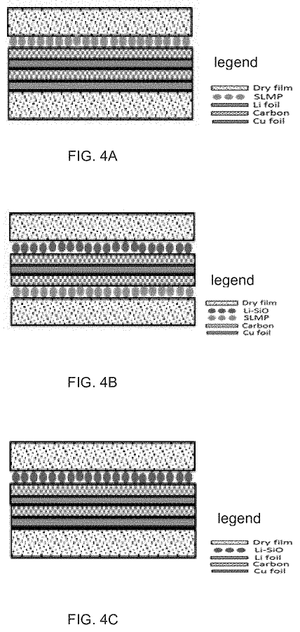

Prelithiated double side coated layer dry electrode configurations are shown in FIGS. 4A-C.

FIG. 4A illustrates a prelithiated double side coated layer dry electrode comprising a first dry film layer, a SLMP layer, a carbon coated current collector comprising a Cu foil between two carbon layers, a Li foil layer, and a second dry film layer. The legend for FIG. 4A is shown to the immediate right of this figure. FIG. 4B illustrates a prelithiated double side coated layer dry electrode configuration comprising a first dry film layer, a Li—SiO layer, a carbon coated current collector comprising a Cu foil between two carbon layers, a SLMP layer, and a second dry film layer. The legend for FIG. 4B is shown to the immediate right of this figure. FIG. 4C illustrates a prelithiated double side coated layer dry electrode comprising a first dry film layer, a Li—SiO layer, a carbon coated current collector comprising a Cu foil between two carbon layers, a Li foil layer, and a second dry film layer. The legend for FIG. 4C is shown to the immediate right of this figure.

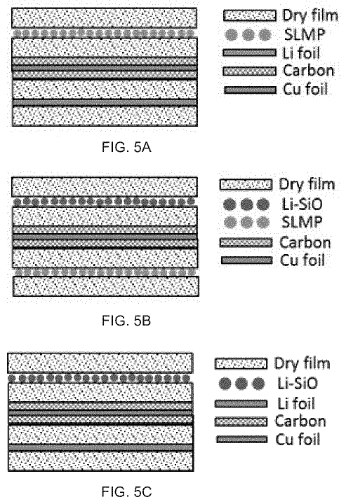

FIGS. 5A-C illustrate prelithiated double side coated layer dry electrode embodiments, with corresponding legends shown to the right of each. FIG. 5A illustrates a Dry film/SLMP/Dry film//Dry film/Li-foil/Dry film configuration. FIG. 5B illustrates a Dry film/Li—SiO/Dry film/CC/Dry film/SLMP/Dry film configuration. FIG. 5C illustrates a Dry film/Li foil/Dry film/CC/Dry film/Li foil/Dry film. CC stands for Carbon-coated current collector configuration, although embodiments similar to FIGS. 5A-5C, but with “bare current collectors” (i.e., without carbon or other coatings) are possible.

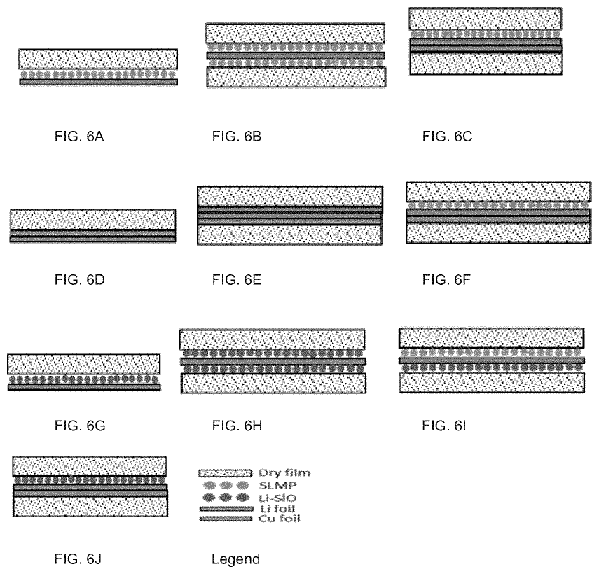

FIGS. 6A-J illustrate prelithiated single (or double) side layer dry electrode configuration. FIG. 6A illustrates layers of dry film/SLMP/bare current collector foil (BC). FIG. 6B illustrates layers of Dry film/SLMP/BC/SLMP/Dry film. FIG. 6C illustrates layers of Dry film/SLMP/BC/Li foil/Dry film. FIG. 6D illustrate layers of Dry film/Li foil/BC. FIG. 6E illustrates layers of Dry film/Li foil/BC/Li foil/Dry film. FIG. 6F illustrates layers of Dry film/SLMP/CC/Li foil/Dry film. FIG. 6G illustrates layers of Dry film/Li—SiO/BC. FIG. 6H illustrates layers of Dry film/Li—SiO/BC/Li—SiO/Dry film. FIG. 6I illustrates layers of Dry film/SLMP/BC/Li—SiO/Dry film. FIG. 6J illustrates layers of Dry film/Li—SiO/BC/Li foil/Dry film. The legend for FIGS. 6A-J is shown to the right of FIG. 6J.

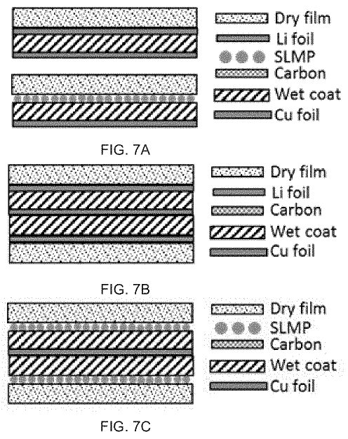

FIGS. 7A-C shows prelithiated multilayer dry electrodes that include at least one multilayer dry film (similar to that described with respect to FIG. 1A), and which includes a wet-coated layer. FIG. 7A illustrates a Dry film/Li foil/wet coated electrode (WE) at the top and a Dry film/SLMP/WE at the bottom. The legend for FIG. 7A is shown to the immediate right of this figure. FIG. 7B illustrates a Dry film/Li foil/double side wet coated electrode (DWE)/Li foil/Dry film. The legend for FIG. 7B is shown to the immediate right of this figure. FIG. 7C illustrates a Dry film/SLMP/DWE/SLMP/Dry film. The legend for FIG. 7C is shown to the immediate right of this figure. Carbon is shown in the legend, and the current collectors can be carbon-coated, although they are shown as bare current collectors.

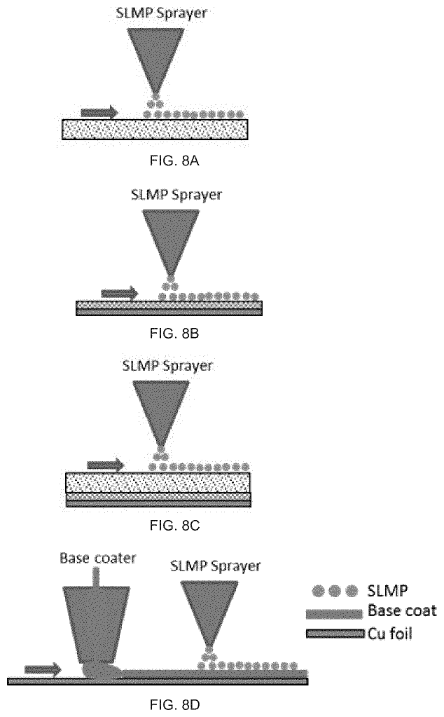

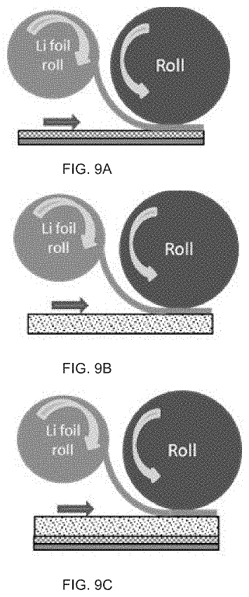

FIGS. 8A-D and FIGS. 9A-C illustrate SLMP powder distribution through a sprayer and lamination of Li foil through a roller onto free standing dry film or dry film laminated on current collector or carbon-coated current collector in large scale mass production. Conventional printing technology such as screen printing and ink jet printing can also be used to spray SLMP powder on to an electrode component. In some experiments, SLMP powder was manually “sprinkled” onto a Li foil, dispersed using a brush, and laminated on to the Li foil using a hand roller.

FIGS. 8A-D illustrate the distribution of SLMP. FIG. 8A illustrates SLMP distribution on dry film, e.g., with a sprayer or any other suitable apparatus for applying SLMP or similar bulk prelithiating material. FIG. 8B illustrates SLMP distribution on a carbon-coated current collector foil. FIG. 8C illustrates SLMP distribution on a dry film laminated onto carbon-coated current collector foil. FIG. 8D illustrates the distribution of a base coat on Cu foil followed by SLMP dispersion. The legend for FIGS. 8A-D is shown to the right of FIG. 8D.

FIGS. 9A-C are schematic drawings of Li foil lamination to other layers described herein. The legend from FIG. 7A applies to FIGS. 9A-9C. The lamination can be performed in different ways, for example, using rollers as shown to perform calendering. FIG. 9A illustrates Li foil lamination onto a carbon-coated current collector foil. Li foil can be provided, for example, from a supply roll, which is initially unrolled. The Li foil can then be fed to, rolled and laminated onto the carbon-coated current collector foil using rollers, such as the double roll calendering equipment shown. FIG. 9B illustrates Li foil lamination on a dry film, such as a dry free standing active layer. Li foil is rolled and laminated onto the dry film similar to the lamination described above with respect to FIG. 9A. FIG. 9C illustrates Li foil lamination on a dry film that is shown previously laminated onto a carbon-coated current collector foil. Li foil is rolled and laminated onto the dry film laminated onto carbon-coated current collector foil, similar to the lamination described above with respect to FIGS. 9A and 9B. The constituents shown in the legend from FIG. 7A apply to those constituents shown in FIGS. 9A-9C.

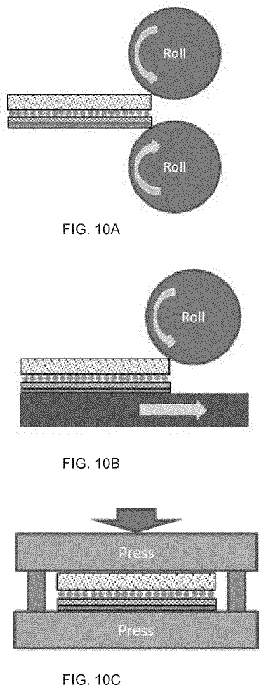

FIGS. 10A-C show illustrations of representative methods to laminate Li-doped layered electrode or other multi-layer structures described herein. The constituents shown in the legend from FIG. 7A applies to those constituents shown in FIGS. 10A-10C. The layered electrode can be laminated under various pressures and wide temperature conditions, ranging from ambient temperature to elevated temperature above melting points of electrode component such as binders that significantly reduces contact resistance between layers. The optimal pressure and temperature can be determined by active material, binder, electrode composition, and layered electrode configuration.

FIG. 10A illustrates the lamination of prelithiated layer dry electrode through a double roll calender. A calender is used both at the top and at the bottom. FIG. 10B illustrates the lamination of prelithiated layer dry electrode through a single roll calender. A calender is used only at the top or at the bottom, with a belt or other structure providing support on the opposite side of the layers. FIG. 10C illustrates the lamination of prelithiated layer dry electrode through a press. Pressure is applied on one side of the press, as shown, or both sides. These steps in FIGS. 8A-10C can be implemented or otherwise modified, in any sequence and combination, to provide the various embodiments of the electrodes or electrode-forming structures illustrated in FIGS. 1A-7C. Other layer-forming steps and sequences not shown in FIGS. 8A-10C can also be implemented.

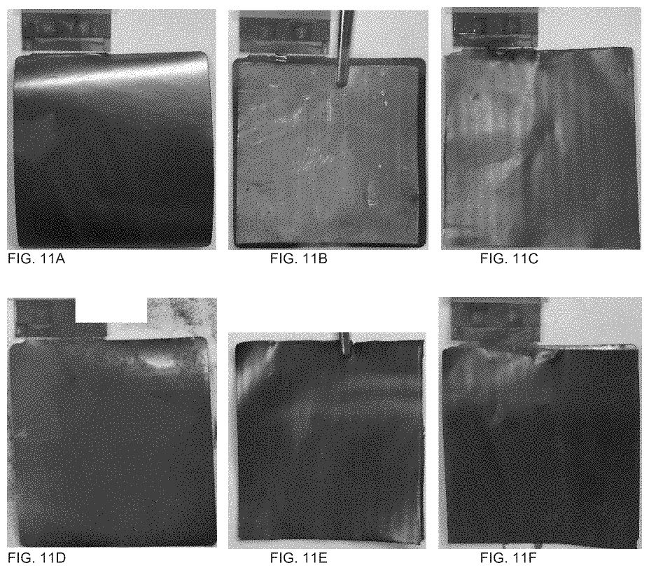

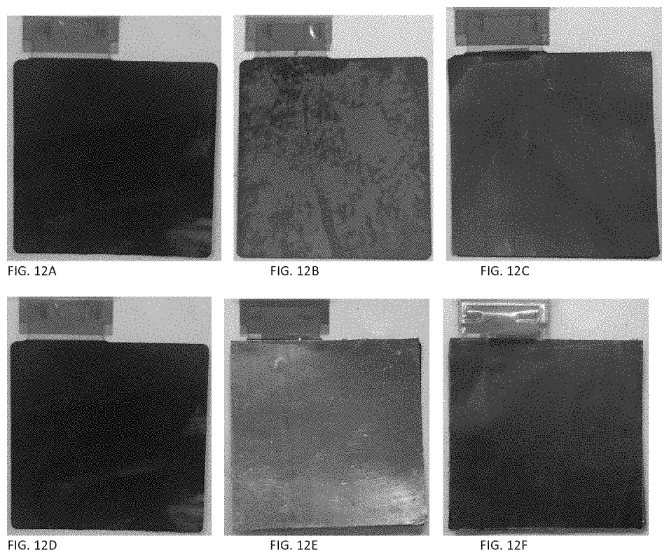

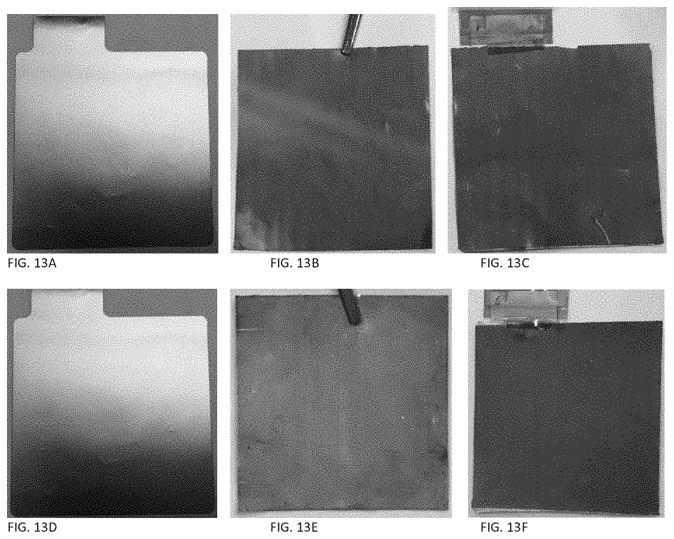

FIGS. 11A-F, FIGS. 12A-F and FIGS. 13A-F show images of actual layered electrode or electrode preparation embodiments taken from preliminary experiments using Li foil and SLMP doped layered electrode configuration. Note that the thick lithium foil used retains its activity and provides a surplus lithium source during cell operation. For SLMP-doped layer electrode, the SLMP powder distribution on the dry film surface may be inhomogeneous, leading to non-uniform prelithiation on dry electrode film. In further development, thinner lithium foil can be used, or the lithium foil can be thinned by mechanical calendering under various layer structures or lamination process, and SLMP dispersion can be improved by precision coating method.

FIGS. 11A-F illustrate images of prelithiated layer electrodes or preparations. FIG. 11A illustrates a dry film laminated on carbon-coated Cu foil. This forms a dry electrode. FIG. 11B illustrates Li foil laminated onto the dry electrode in FIG. 11A to form a multilayer dry electrode. FIG. 11C illustrates a prelithiated layer electrode made of dry film laminated onto the layers shown in FIG. 11B. FIG. 11C illustrates a prelithiated layer electrode made of dry film and Li foil laminated onto the dry electrode, which is made up of a dry film laminated on a carbon coated Cu foil.

FIG. 11D illustrates SMLP laminated onto a dry electrode to form a multilayer dry electrode. FIG. 11E illustrates a free standing dry film. FIG. 11F illustrates the free standing dry film of FIG. 11E laminated onto the SMLP and dry electrode of FIG. 11D. FIG. 11F illustrates a prelithiated layer electrode made up of a dry film, SLMP and a dry electrode.

FIGS. 12A-F illustrate images of prelithiated layer electrodes or preparations. FIG. 12A illustrates a carbon coated Cu foil. FIG. 12B illustrates SLMP laminated onto the carbon coated Cu foil as illustrated in FIG. 12A. FIG. 12C illustrates a dry film laminated onto the layers as shown in FIG. 12B. FIG. 12C illustrates a prelithiated layer electrode made of a dry film, SLMP and carbon coated Cu foil.

FIG. 12D illustrates a carbon coated Cu foil. FIG. 12E illustrates Li foil laminated onto the carbon coated Cu foil of FIG. 12D. FIG. 12F illustrates a dry film laminated onto the layers of FIG. 12D. FIG. 12F illustrates a prelithiated layer electrode made of a dry film, a Li foil and a carbon coated Cu foil.

FIGS. 13A-F illustrate images of prelithiated layer electrode preparations. FIG. 13A illustrates a bare Cu foil. FIG. 13B illustrates SMLP laminated onto a dry film. FIG. 13C illustrates the layers of FIG. 13B laminated onto the layer of FIG. 13A. FIG. 13C illustrates a prelithiated layer dry electrode made of a dry film, SLMP and bare Cu foil.

FIG. 13D illustrates a bare Cu foil. FIG. 13E illustrates a Li foil. FIG. 13F illustrates a dry film laminated onto the Li foil of FIG. 13E and the bare Cu foil of FIG. 13D. FIG. 13F illustrates a prelithiated layer electrode made of a dry film, a Li foil and a bare Cu foil.

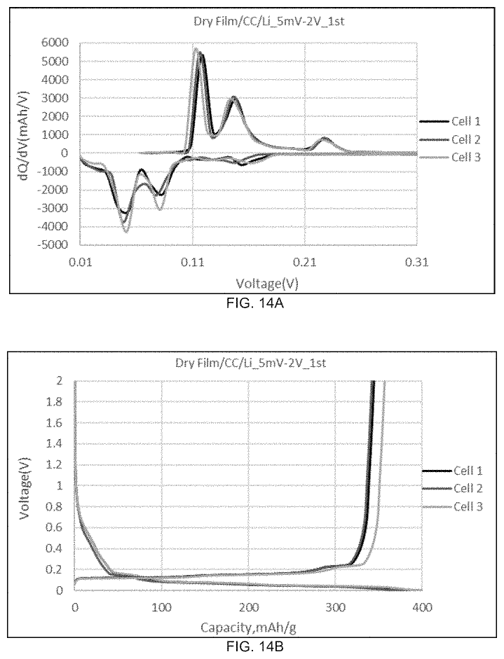

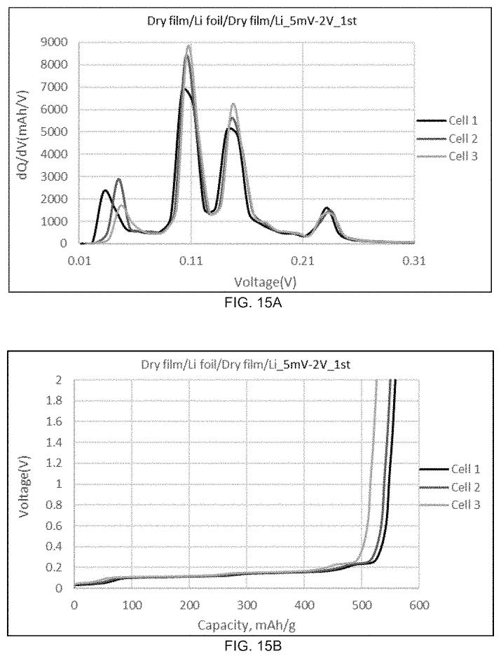

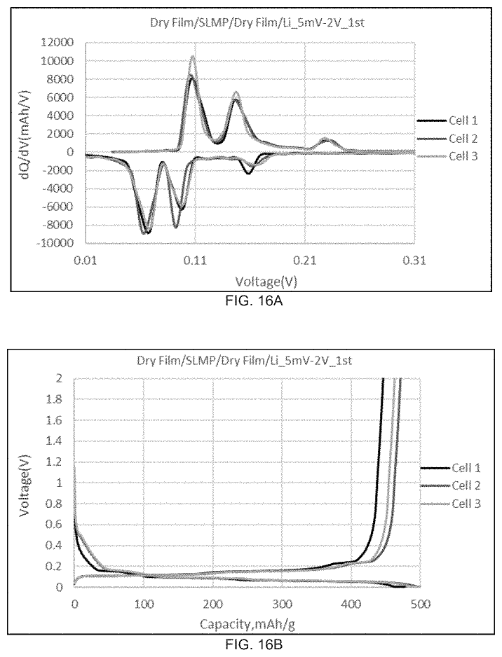

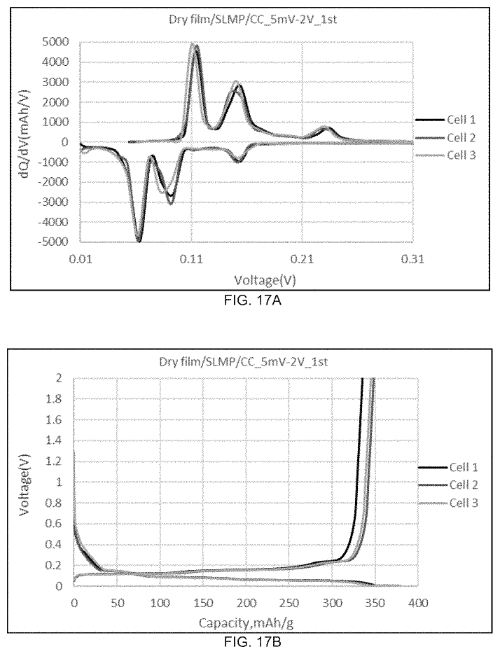

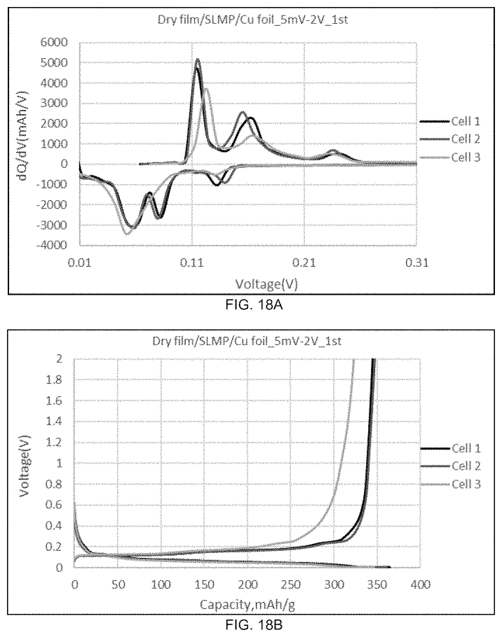

FIGS. 14A-B, FIGS. 15A-B, FIGS. 16A-B, FIGS. 17A-B, and FIGS. 18A-B show differential capacity and voltage profiles of the 1^{st} formation cycle for various electrodes, as described further below.

The SLMP-doped layer electrodes exhibited voltage and differential capacity profiles similar to typical prior art non-lithium containing dry electrode, whereas Li foil-doped layer electrodes produced only delithiation voltage curves because their OCV was as low as around 20 mV indicating a highly lithiated electrode. As a result, the Li foil layer electrode laminated can be directly delithiated unlike SLMP-doped layer electrode which required an initial lithiation cycle. In FIG. 15B, the initial plateau at lower voltage close 0.01V before the specific capacity of about 50 mAh/g is likely due to excess lithium plated on the electrode surface during prelithiation step. The prelithiation level can be readily tune by adjusting the amount of lithium foil used in the electrode laminate structure.

FIGS. 14A-B illustrate the differential capacity and voltage profiles of 1^{st} formation cycle for a conventional dry electrode. FIG. 14A illustrates differential capacity of 1^{st} formation cycle for previously known dry electrode where dry film was laminated on carbon-coated Cu foil without lithium through a calendering process. FIG. 14B illustrates voltage profiles of 1^{st} formation cycle for a conventional dry electrode where dry film was laminated on carbon-coated Cu foil without lithium through a calendering process.

FIGS. 15A-B illustrate differential capacity and voltage profiles of 1^{st} formation cycle for dry film/Li foil/dry film/carbon-coated Cu foil layer electrode half pouch cell. FIG. 15A illustrates differential capacity profiles of 1^{st} formation cycle for Dry film/Li foil/Dry film/Carbon-coated Cu foil layer electrode half pouch cell. FIG. 15B illustrates voltage profiles of 1^{st} formation cycle for Dry film/Li foil/Dry film/Carbon-coated Cu foil layer electrode half pouch cell.

FIGS. 16A-B illustrate differential capacity and voltage profiles of 1^{st} formation cycle for Dry film/SLMP/Dry film/Carbon-coated Cu foil layer electrode half pouch cell. FIG. 16A illustrates differential profiles of 1^{st} formation cycle for Dry film/SLMP/Dry film/Carbon-coated Cu foil layer electrode half pouch cell. FIG. 16B illustrates voltage profiles of 1^{st} formation cycle for Dry film/SLMP/Dry film/Carbon-coated Cu foil layer electrode half pouch cell.

FIGS. 17A-B illustrate differential capacity and voltage profiles of 1^{st} formation cycle for Dry film/SLMP/Carbon-coated Cu foil layer electrode half pouch cell. FIG. 17A illustrates differential capacity of 1^{st} formation cycle for Dry film/SLMP/Carbon-coated Cu foil layer electrode half pouch cell. FIG. 17B illustrates voltage profiles of 1^{st} formation cycle for Dry film/SLMP/Carbon-coated Cu foil layer electrode half pouch cell.

FIGS. 18A-B illustrate differential capacity and voltage profiles of 1^{st} formation cycle for Dry film/SLMP/Bare Cu foil layer electrode half pouch cell. FIG. 18A illustrates differential capacity profiles of 1^{st} formation cycle for Dry film/SLMP/Bare Cu foil layer electrode half pouch cell. FIG. 18B illustrates voltage profiles of 1^{st} formation cycle for Dry film/SLMP/Bare Cu foil layer electrode half pouch cell.

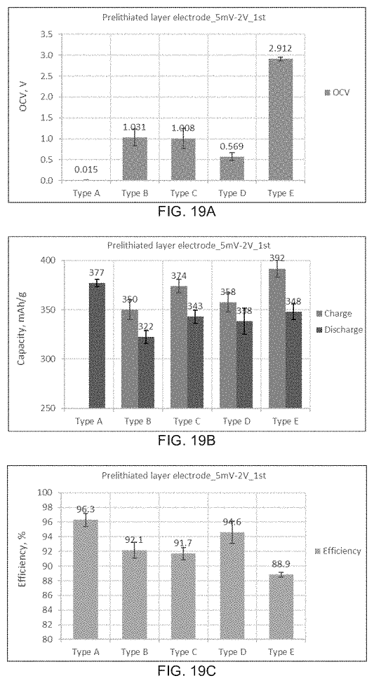

FIGS. 19A-C report cell open circuit voltage (OCV) prior to formation 1^{st} formation cycle charge/discharge specific capacity and efficiency for four different electrode configuration. Type E is a non-lithium containing dry coated electrode noted in Table 7. The Li foil-doped layer electrode showed significantly lower OCV prior to formation compared to those of SLMP-doped layer electrodes, indicating a fully prelithiated layer electrode. The SLMP-doped layer electrode delivered slightly lower lithiation (charge) capacity and higher delithiation (discharge) capacity, comparable to prior art. As such, the SLMP-doped layer electrodes substantially improved the 1^{st} cycle coulombic efficiency, demonstrating prelithiation activity by SLMP in the layer electrode.

FIGS. 19A-C report cell open circuit voltage (OCV) prior to formation, 1^{st} formation cycle charge/discharge specific capacity and efficiency for four different electrode configuration. FIG. 19A illustrates the OCV prior to formation of the prelithiated layer electrode half cell. FIG. 19B illustrates the capacity of prelithiated layer electrode half cell. FIG. 19C illustrates the efficiency of prelithiated layer electrode half cell. Note that the efficiency of Type A was computed based on charge capacity of Type E control cell.

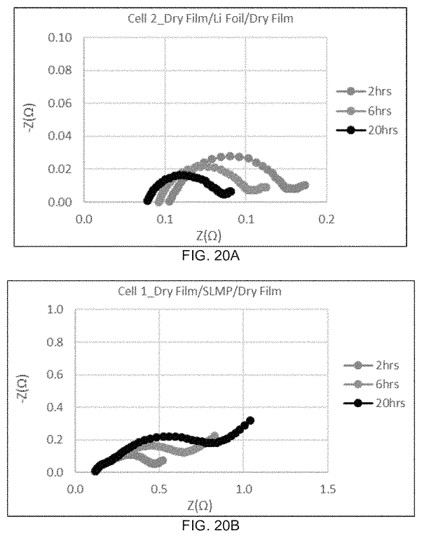

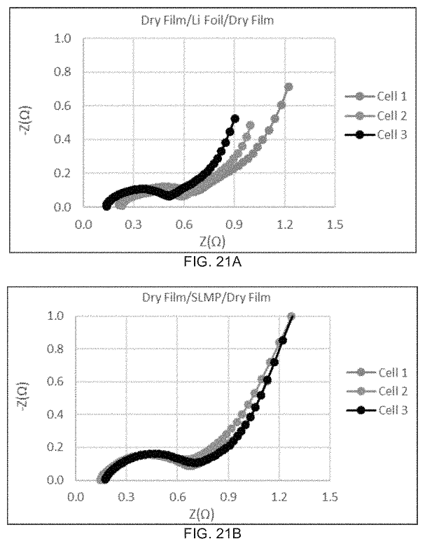

FIGS. 20A-B and FIGS. 21A-B show electrochemical impedance spectroscopy of Li-doped layer electrode against a lithium reference electrode measured over the prelithiation period and post-formation cycle. Li foil-doped layer electrode showed decreased electrolyte bulk resistance and increased electrode impedance over prelithiation period, while SLMP-doped layer electrode exhibited increasing impedance over prelithiation process. After the 1^{st} formation cycle, the Li foil-doped layer electrode showed slightly lower electrode impedance than those of SLMP-doped layer electrode. SLMP-doped layer electrode exhibited consistent electrode impedance.

FIGS. 20A-B illustrate the Nyquist plots of prelithiated layer electrode during rest period prior to formation of a Dry film/Li foil/Dry film/Carbon-coated Cu foil and a Dry film/SLMP/Dry film/Carbon-coated Cu foil. FIG. 20A illustrates a Nyquist plot of prelithiated layer electrode during rest period prior to formation of a Dry film/Li foil/Dry film/Carbon-coated Cu foil. FIG. 20B illustrates a Nyquist plot of prelithiated layer electrode during rest period prior to formation of a Dry film/SLMP/Dry film/Carbon-coated Cu foil.

FIGS. 21A-B illustrate Nyquist plots of prelithiated layer electrode measured after 1^{st} formation cycle of a Dry film/Li foil/Dry film/Carbon-coated Cu foil and a Dry film/SLMP/Dry film/Carbon-coated Cu foil. FIG. 21A illustrates the Nyquist plot of prelithiated layer electrode measured after 1^{st} formation cycle of a Dry film/Li foil/Dry film/Carbon-coated Cu foil. FIG. 21B illustrates the Nyquist plot of prelithiated layer electrode measured after 1^{st} formation cycle of a Dry film/SLMP/Dry film/Carbon-coated Cu foil.

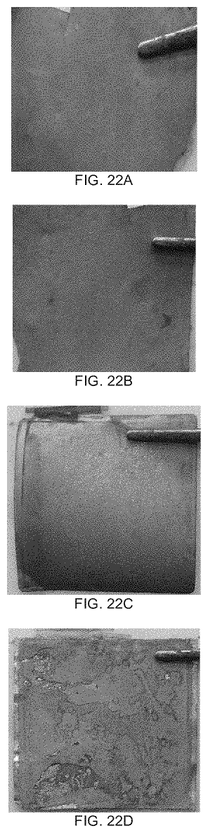

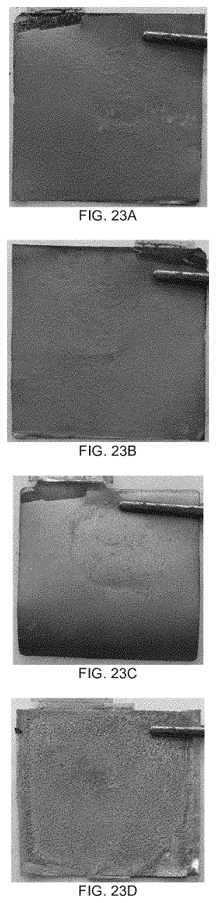

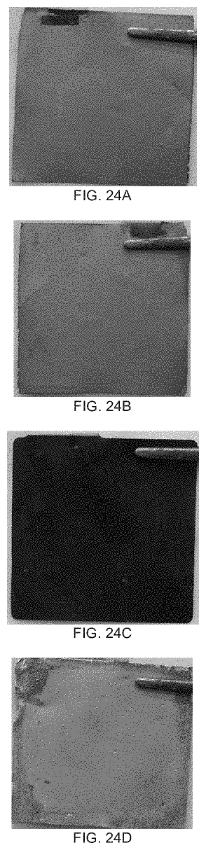

To provide visual support of uniform lithiation from the embedded lithium metal or SLMP powder cell packaging was removed to gain access to the prelithiated multilayer electrode. FIGS. 22A-D, FIGS. 23A-D and FIGS. 24A-D show images of lithiated dry film and electrode, and lithium metal electrode taken from fully charged Dry film/Li-foil/Dry film/C/Cu foil (FIGS. 22A-D) and Dry film/SLMP/Dry film/C/Cu foil layer electrode (FIGS. 23A-D), and Dry film/SLMP/Carbon-coated Cu foil (FIGS. 24A-D) followed by 1^{st} formation cycle. Note that the doped Li foil and SLMP were fully reacted over the prelithiation step followed by formation cycle. All dry films exhibited uniform lithiation as supported by the golden surfaces.

FIGS. 22A-D illustrate images of electrodes based on Cell 1 as presented in FIGS. 15A-B.

FIG. 22A illustrates an image of an electrode, based on Cell 1 as presented in FIGS. 15A-B, after it underwent 1^{st} formation cycle followed by one condition cycle and fully lithiated Dry film and a side faced Li metal electrode. FIG. 22B illustrates an image of an electrode, based on Cell 1 as presented in FIGS. 15A-B, after it underwent 1^{st} formation cycle followed by one condition cycle and fully lithiated Dry film and a side faced lithium foil.

FIG. 22C illustrates an image of an electrode, based on Cell 1 as presented in FIGS. 15A-B, after it underwent 1^{st} formation cycle followed by one condition cycle and fully lithiated Dry film laminated on carbon-coated Cu foil.

FIG. 22D illustrates an image of an electrode, based on Cell 1 as presented in FIGS. 15A-B, after it underwent 1^{st} formation cycle followed by one condition cycle and fully lithiated lithium metal electrode faced Dry film taken from Dry film/Li foil/Dry film/Carbon-coated Cu foil layer electrode.

FIGS. 23A-D illustrates images of electrodes based on Cell 1 as presented in FIGS. 16A-B.

FIG. 23A illustrates an image of an electrode, based on Cell 1 as presented in FIG. 16, after it underwent 1^{st} formation cycle followed by one condition cycle and fully lithiated Dry film and a side faced Li metal electrode.

FIG. 23B illustrates an image of an electrode, based on Cell 1 as presented in FIGS. 16A-B, after it underwent 1^{st} formation cycle followed by one condition cycle and fully lithiated Dry film and a side faced SLMP.

FIG. 23C illustrates an image of an electrode, based on Cell 1 as presented in FIGS. 16A-B, after it underwent 1^{st} formation cycle followed by one condition cycle and fully lithiated Dry film laminated on carbon-coated Cu foil.

FIG. 23D illustrates an image of an electrode, based on Cell 1 as presented in FIGS. 16A-B, after it underwent 1^{st} formation cycle followed by one condition cycle and fully lithiated lithium metal electrode faced Dry film taken from Dry film/SLMP/Dry film/Carbon-coated Cu foil layer electrode

FIGS. 24A-D illustrate images of electrodes based on Cell 1 as presented in FIGS. 17A-B.

FIG. 24A illustrates an image of an electrode, based on Cell 1 as presented in FIGS. 17A-B, after it underwent 1^{st} formation cycle followed by one condition cycle and fully lithiated Dry film and a side faced Li metal electrode.

FIG. 24B illustrates an image of an electrode, based on Cell 1 as presented in FIGS. 17A-B, after it underwent 1^{st} formation cycle followed by one condition cycle and fully lithiated Dry film and a side faced SLMP.

FIG. 24C illustrates an image of an electrode, based on Cell 1 as presented in FIGS. 17A-B, after it underwent 1^{st} formation cycle followed by one condition cycle and fully lithiated Carbon-coated Cu foil.

FIG. 24D illustrates an image of an electrode, based on Cell 1 as presented in FIGS. 17A-B, after it underwent 1^{st} formation cycle followed by one condition cycle and fully lithiated lithium metal electrode faced Dry film taken from Dry film/SLMP/Carbon-coated Cu foil layer electrode.

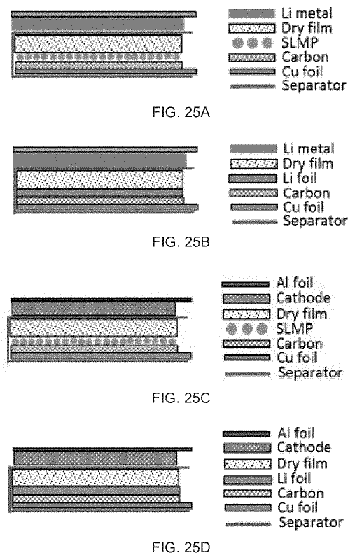

FIGS. 25A-D shows illustrations of single side layer electrode half cell and full cell where the anode consists of SLMP and Li foil for prelithiation. The cell configuration can be used for other Li-doped multilayer electrodes (Refer to FIG. 2). Li foil in layer electrode can act as secondary lithium source during continuous cell operation. The use of prelithiated multilayer anode against NMC cathodes (NMC622 and NMC811) or NCA cathode in full cell format is under investigation.

FIGS. 25A-D illustrate schematic drawings of prelithiated layer electrodes. FIG. 25A illustrates half cell prelithiated layer electrode made of Cu foil/Li metal/Separator/Dry film/SLMP/Carbon/Cu foil/Separator. FIG. 25B illustrates half cell prelithiated layer electrode made of Cu foil/Li metal/Separator/Dry film/Li foil/Carbon/Cu foil/Separator. FIG. 25C illustrates a full cell for electrochemical testing prelithiated layer electrode made of Al foil/Cathode/Separator/Dry film/SLMP/Carbon/Cu foil/Separator. FIG. 25D illustrates a full cell for electrochemical testing prelithiated layer electrode made of Al foil/Cathode/Separator/Dry film/Li foil/Carbon/Cu foil/Separator.

### EXAMPLES

As illustrated in Table 1, SLMP from FMC Li foil from GFL International and Li-doped SiO (Li—SiO, KSC-7126 from Shin-Etsu) were used as lithium source for prelithiation in Li-doped layered electrode configuration.

TABLE 1
Specification of SLMP, Li foil and Li—SiO material used for prelithiation.

| Material | Product | Li | BET | D10 | D50 | D90 | Thick. |
|---|---|---|---|---|---|---|---|
| SLMP | Lectro Max 100 | ≥97% | — | — | 25-60 μm | — | — |
| Li foil | — | ≥99.3% | — | — | — | — | 100 μm |
| Li—SiO | KSC-7126 | — | 2.3 m²/g | 3 μm | 5.7 μm | 9.8 μm | — |

As illustrated in Table 2, active materials used in some examples include surface modified artificial graphite (SMG-A5 from Hitachi Chemicals) and NMC622 (HX12TH from Umicore) for anode and cathode, respectively.

TABLE 2
Specification of active material

| | | Tab | | | | |
|---|---|---|---|---|---|---|
| Product | BET | density | D10 | | D50 | D90 |
| SMG-A5 | 2.7 m²/g | 0.93 g/cm³ | 6.5 | μm | 17.4 μm | 35.2 μm |
| NMC622 | 1.8 m²/g | 1.12 g/cm³ | 11.8 | μm | 20.4 μm | 34.2 μm |

As illustrated in Table 3, PTFE (CD123E from Asahi Glass), PVDF (KF3121-50 from Arkema) and CMC (CRT2000PPA from DOW) binder were used in dry electrode film. All materials were used as received without drying or further treatment process.

TABLE 3
Specification of polymer binder

| | | Melting | | | | | | | |
|---|---|---|---|---|---|---|---|---|---|
| Binder | Product | point | | D10 | | D50 | | D90 | |
| CMC | CRT 2000PPA | 270° | C. | 23.8 | μm | 69.5 | μm | 237 | μm |
| PVDF | KF3121-50 | 161-168° | C. | 5.5 | μm | 15.5 | μm | 49.3 | μm |
| PTFE | CD123E | 327-342° | C. | 156.3 | μm | 381.6 | μm | 767.3 | μm |

As illustrated in Table 4 and Table 5, both cathode and anode dry electrode films were fabricated through pilot scale production process. Table 4 provides compositions for cathode and anode electrode, and specifications of free standing dry electrode film is provided in Table 5.

TABLE 4
Composition of cathode and anode dry electrode

| | | Carbon | | | |
|---|---|---|---|---|---|
| Electrode | Active | additive | PTFE | PVDF | CMC |
| Cathode | 95 wt % | 3 wt % | 2 wt % | — | — |
| | NMC622 | | | | |
| Anode | 96.15 wt % | — | 2 wt % | 1 wt % | 0.85 wt % |
| | SMG-A5 | | | | |

TABLE 5
Specifications of free standing dry electrode film.

| Electrode | Loading | Density | Thickness |
|---|---|---|---|
| Cathode | 35.5 mg/cm² | 3.05 g/cc | 117 μm |
| Anode | 19.5 mg/cm² | 1.42 g/cc | 137 μm |

### Electrochemical Characterization

Li-doped layer electrode was paired with lithium electrode and sealed in a pouch filled with electrolyte, as illustrated in Table 6. The sealed cell was stored under compression using a clamp for prelithiation for about 20 hrs before formation that was carried out at C/20-C/25 rate.

TABLE 6
Electrolyte composition used for electrochemical test

| EC | EMC | DMC | PC | VC | LiPF₆ |
|---|---|---|---|---|---|
| 25.89 | 38.29 | 16.17 | 4.56 | 1 | 14.09 |
| wt % | wt % | wt % | wt % | wt % | wt % |

Table 7 provides representative single side prelithiated layer electrode used for preliminary electrochemical testing presented in FIGS. 14-19, and electrochemical evaluation for other configurations are under progress.

TABLE 7
Prelithiated layer electrode used in preliminary
experimental and presented in FIGS. 14-18. Type
E represents typical dry coated electrode.

| Type | Configuration |
|---|---|
| A | Dry film/Li foil/Dry film/Carbon- |
| | coated Cu foil |
| B | Dry film/SLMP/Dry film/Carbon- |
| | coated Cu foil |
| C | Dry film/SLMP/Carbon-coated Cu |
| | foil |
| D | Dry film/SLMP/Bare Cu foil |
| E | Dry film/Carbon-coated Cu foil |

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products. For example, any of the components for an energy storage system described herein can be provided separately, or integrated together (e.g., packaged together, or attached together) to form an energy storage system.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

1. A multilayer dry film for electrode film fabrication, comprising:
a dry free-standing active layer comprising a first dry active material and a first dry binder; and
a dry prelithiating layer comprising lithium, wherein the first dry free-standing active layer and the dry prelithiating layer are laminated to each other to form a free-standing multilayer dry film.

2. The multilayer dry film of claim 1, wherein the dry free-standing active layer comprises a first active layer, the multilayer dry film further comprises a second active layer, and the second active layer comprises a second active material.

3. A multilayer dry electrode film comprising the multilayer dry film of claim 2, wherein the prelithiating layer is positioned between the first active layer and the second active layer.

4. The multilayer dry electrode film of claim 3, wherein the second active layer comprises a second dry active layer, the second active material comprises a second dry active material, and the second dry active layer further comprises a second dry binder.

5. The multilayer dry electrode film of claim 3, wherein at least one of the type and amount of the first active material and the second active material is different between the first active layer and the second active layer.

6. The multilayer dry film of claim 1, wherein the dry prelithiating layer comprises at least one of lithium foil, stabilized lithium metal powder (SLMP), and lithium-doped silicon or silicon oxide (SiO) or silicon compound.

7. (canceled)

8. (canceled)

9. (canceled)

10. The multilayer dry film of claim 2, wherein the first active layer and the second active layer have substantially the same compositions.

11. (canceled)

12. A multilayer dry electrode comprising:
a current collector comprising a first side and a second side; and
the multilayer dry electrode film of claim 3 laminated to the first side of the current collector.

13. (canceled)

14. (canceled)

15. A double sided multilayer dry electrode comprising:
the multilayer dry electrode of claim 12; and
a second multilayer dry electrode film laminated to the second side of the current collector.

16. The double sided multilayer dry electrode of claim 15, wherein the first prelithiating layer of the first multilayer dry electrode film is a different material from a second prelithiating layer of the second multilayer dry electrode film.

17. The double sided multilayer dry electrode of claim 15, wherein the first multilayer dry electrode film is of the opposite polarity as the second multilayer dry electrode film.

18. (canceled)

19. (canceled)

20. (canceled)

21. (canceled)

22. An energy storage device comprising the double sided multilayer dry electrode of claim 15.

23. A method of fabricating a multilayer dry film for an electrode, comprising:
providing a dry free-standing active layer comprising a first dry active material and a first dry binder; and
forming a free-standing multilayer dry film by laminating a dry prelithiating layer comprising lithium onto the dry free-standing active layer.

24. The method of claim 23, wherein forming the free-standing multilayer dry film further comprises laminating a second active layer onto the dry prelithiating layer to form a multilayer dry electrode film.

25. The method of claim 23, wherein the dry prelithiating layer comprises lithium foil.

26. The method of claim 23, further comprising compressing stabilized lithium metal powder (SLMP) to form the dry prelithiating layer.

27. The method of claim 26, wherein compressing the SLMP and forming the free-standing multilayer dry film are performed approximately simultaneously.

28. (canceled)

29. The method of claim 26, further comprising placing the SLMP onto the dry free-standing active layer prior to the compressing the SLMP.

30. (canceled)

31. The method of claim 23, further comprising wet-coating a second active layer onto the dry prelithiating layer to form a multilayer dry electrode film.

32. A method of fabricating a multilayer electrode comprising:
fabricating a first multilayer dry electrode film according to the method of claim 23;
providing a current collector comprising a first side and a second side; and
laminating the first multilayer dry electrode film to the first side of the current collector to form a multilayer electrode.

33. The method of claim 32, further comprising:
providing a second multilayer dry electrode film; and
laminating the second multilayer dry electrode film to the second side of the current collector to form a double sided multilayer electrode.

34. (canceled)

35. (canceled)

36. A method of prelithiating a multilayer dry film for an electrode, comprising:
fabricating a multilayer dry film according to claim 23; and
tuning the amount of prelithiation.

37. The method of claim 36, wherein tuning comprises compressing the multilayer dry film.
